(19) United States
(12) Patent Application Publication
(10) Pub. No.: US 2008/0231186 A1
(43) Pub. Date: Sep. 25, 2008

(54) PLASMA DISPLAY PANEL, METHOD FOR MANUFACTURING THE SAME, AND RELATED TECHNOLOGIES

(75) Inventors: Sung Tae KIM, Seoul (KR); Won Seok JEON, Seoul (KR); Nam Seok KANG, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/052,205

(22) Filed: Mar. 20, 2008

(30) Foreign Application Priority Data
Mar. 20, 2007 (KR) 10-2007-0027184

(51) Int. Cl. H01J 17/49; H01J 9/20

(52) U.S. Cl. 313/582; 445/24

(57) ABSTRACT

A plasma display panel is disclosed. A method for manufacturing the plasma display panel includes: forming address electrodes and a first dielectric layer on a first substrate; forming barrier ribs by stacking a photosensitive barrier rib material, containing a hybrid binder, on the first substrate, and processing the stacked photosensitive barrier rib material; coating phosphor layers in respective cells defined by the barrier ribs; sequentially forming a plurality of transparent electrodes and bus electrodes, a second dielectric layer, and a protective layer on a second substrate; and bonding the first substrate and the second substrate with each other.

### RELATED TECHNOLOGIES

This application claims the benefit of the Korean Patent Application No. P 10-2007-0027184, filed on, Mar. 20, 2007, which is hereby incorporated by reference as if fully set forth herein.

### BACKGROUND

1. Field

This disclosure relates to a plasma display panel, which may have a barrier rib, a method for forming the same, and related technologies.

2. Discussion of the Related Art

With the advent of a multimedia age, there is a rising demand for the appearance of a more delicate and larger display device capable of representing colors closer to natural colors. Current cathode ray tubes (CRTs) are generally limited in their application to large-scale screens of 40 inches or more. Consequently, liquid crystal displays (LCDs), plasma display panels (PDPs), projection televisions (TVs), etc. are now being used for large-scale screens and high-definition imaging fields of larger size.

Characteristics of the above-mentioned display devices including the PDP are that the display devices can be manufactured with a thinner thickness than the self-luminous CRT, achieve easy manufacture of a flat large-scale screen (for example, 60˜80 inches), and be clearly distinguished from the conventional CRT with respect to style or design.

The PDP includes a lower panel having address electrodes, an upper panel having sustain electrode pairs, and discharge cells defined by barrier ribs. A phosphor is coated in each of the discharge cells, to display an image. More specifically, if a discharge occurs in a discharge space between the upper panel and the lower panel, ultraviolet rays generated by the discharge are incident to the phosphor to produce visible rays. With the visible rays, an image can be displayed.

The barrier ribs of the plasma display panel can be formed using a screen printing method, sanding method, photosensitive method, etching method, or the like. Here, the photosensitive method has an advantage of more simple manufacture than the sanding method or etching method, although it uses relatively expensive materials.

However, the above-described conventional methods for forming the barrier ribs of the plasma display panel have several problems, which may include one or more of the following.

A photosensitive barrier rib material includes an inorganic material, such as for example glass powder, linked with an organic material such as for example a binder and dispersant. However, when light is incident to the top of the photosensitive barrier rib material, it is possible that the photosensitive barrier rib material may not transmit the light to the bottom thereof due to a refractive index difference between the inorganic material and the organic material. More specifically, in one example, the inorganic material in the photosensitive barrier rib material has a refractive index of about 1.4 to 1.7, and the organic material has a refractive index of about 1.4 to 1.55. During an exposure process, such a refractive index difference between the inorganic material and the organic material causes light to be diffused, rather than reaching the bottom of the barrier rib material. As a result, in this example, the bottom of the barrier rib material cannot achieve a sufficient exposure efficiency.

FIG. 1 is a view illustrating a barrier rib of a plasma display panel, which is formed of a conventional photosensitive barrier rib material. Now, potential problems experienced by a display having a barrier rib, which is formed of a conventional barrier rib material, will be described with reference to FIG. 1.

As shown in FIG. 1, when a barrier rib is formed by externally exposing and developing a conventional photosensitive material, the barrier rib has a low aspect ratio. More specifically, the barrier rib 1, which is formed of the photosensitive barrier rib material, may be configured such that a medium-height portion thereof has a thinnest thickness. As a result, a phosphor 2 is coated only up to the medium-height of the barrier rib 1, and no phosphor is coated at side surfaces of the upper portion of the barrier rib 1. As a consequence, the brightness of the plasma display panel may be deteriorated.

In one implementation, it is possible to address this issue by reducing a refractive index difference between inorganic and organic materials constituting the barrier rib material. For instance, a refractive index of the inorganic material may be decreased, and a refractive index of the organic material may be increased. However, it is actually difficult to find materials satisfying the above requirement. Moreover, although an acrylate-based organic material, in which a bulky group is attached to a side chain, may be used in order to increase the refractive index of the organic material, its use may increase a binder burn out (BBO) temperature of the organic material.

### SUMMARY

Implementations may include a plasma display method and a method for manufacturing the same that substantially obviates one or more problems due to the above or other limitations and/or disadvantages of the related art.

A plasma display panel and a method for manufacturing the same may involve inorganic and organic materials constituting a barrier rib, which have a small refractive index difference.

Furthermore, a method for manufacturing a plasma display panel may involve a photosensitive barrier rib material containing or including a hybrid binder.

Moreover, in one aspect, a method for manufacturing a plasma display panel includes forming address electrodes and a first dielectric layer on a first side of a first substrate; positioning barrier ribs by stacking a photosensitive barrier rib material, including a hybrid binder, on the first side of the first substrate, and processing the stacked photosensitive barrier rib material; positioning phosphor layers in respective cells defined by the barrier ribs; sequentially positioning at least one pair of transparent and bus electrodes, a second dielectric layer, and a protective layer on a first side of a second substrate; and fixing a position of the first substrate relative to a position of the second substrate, with the first side of the first substrate facing the first side of the second substrate.

In accordance with another aspect, there is provided a method for manufacturing a plasma display panel includes positioning a first dielectric layer material, including a hybrid binder, on a first side of a first substrate and address electrodes; stacking a photosensitive barrier rib material, including a hybrid binder, on the first dielectric layer material, and externally exposing and developing the stacked photosensitive barrier rib material; simultaneously baking the first dielectric layer material and barrier rib material, to form a first dielectric layer and barrier ribs; positioning phosphor layers in respective cells defined by the barrier ribs; sequentially positioning at least one pair of transparent and bus electrodes, a second dielectric layer, and a protective layer on a second substrate; and fixing a position of the first substrate relative to a position of the second substrate, with the first side of the first substrate facing the first side of the second substrate.

Exemplary implementations of these methods include various aspects. Specifically, for example, the photosensitive barrier rib material is formed by preparing an inorganic material linked with hydroxyl ions, and synthesizing the inorganic material with an acrylate-based binder. The acrylate-based binder is 3-(Trimethoxysilyl) propyl methacrylate and/or 3-Glycidoxypropyltrimethoxysilane. Also, the inorganic material may be linked with the hydroxyl ions using a negative ion polymerization, and the barrier rib material may further includes an inorganic material, where a refractive index difference between the inorganic material and the acrylate-based binder is 0.15 to 0.2. The photosensitive barrier rib material may be stacked by laminating the photosensitive barrier rib material in the form of a green sheet on the first substrate, and the stacked photosensitive barrier rib material may be processed by externally exposing and developing the photosensitive barrier rib material, and then, by baking the developed photosensitive barrier rib material. The developed photosensitive barrier rib material may be baked at a temperature of 550˜600° C. The phosphor layers may be positioned in respective cells defined by the barrier ribs by coating phosphor on the first dielectric layer and side surfaces of the barrier ribs.

Additionally, in accordance with another aspect, there is provided a plasma display panel including a first panel including address electrodes, a first dielectric layer, and phosphor layers positioned on a first side of a first substrate; a second panel including sustain electrode pairs, a second dielectric layer, and a protective layer positioned on a first side of a second substrate; and barrier ribs provided between the first panel and the second panel and including a parent glass and filler as an inorganic material, and acrylate-based binder.

Implementations of this plasma display panel include various aspects. Specifically, for example, the barrier ribs include 0.01˜0.06 wt % of the acrylate-based binder. Also, a refractive index difference between the inorganic material and the acrylate-based binder may be 0.15 to 0.2, and the barrier ribs may have a refractive index of 1.4 to 1.6. The acrylate-based binder may be at least one of 3-(Trimethoxysilyl) propyl methacrylate and 3-Glycidoxypropyltrimethoxysilane. And, the first dielectric layer may include a parent glass, filler, and acrylate-based binder.

### BRIEF DESCRIPTION OF THE DRAWINGS

The accompanying drawings, which are included to provide a further understanding and are incorporated in and constitute a part of this disclosure, illustrate aspects of the technologies disclosed. In the drawings:

FIG. 1 is a view illustrating a barrier rib of a plasma display panel, which is formed of a conventional photosensitive barrier rib material;

FIG. 2 is a view illustrating a plasma display panel;

FIG. 3 is a view illustrating a method for forming a photosensitive barrier rib material;

FIG. 4 is a view illustrating a method for forming a photosensitive barrier rib material;

FIG. 5 is a view illustrating a driving apparatus and connector of the plasma display panel;

FIG. 6 is a view illustrating a substrate wiring structure of a general tape carrier package;

FIG. 7 is a view diagrammatically illustrating a plasma display panel;

FIGS. 8A to 8J are views illustrating a method for manufacturing a plasma display panel; and

FIGS. 9A and 9B are views illustrating a process for bonding a front substrate and a back substrate of the plasma display panel with each other.

In the drawings, the same reference numbers will be used throughout the drawings to refer to the same or like parts. Also, in the drawings, dimensions of layers and regions may be exaggerated for clarity of description, and a thickness ratio between neighboring layers shown in the drawings may not be intended to represent an actual thickness ratio.

### DETAILED DESCRIPTION

A plasma display panel may be configured in such a manner that an upper panel and a lower panel are bonded with each other while interposing barrier ribs therebetween.

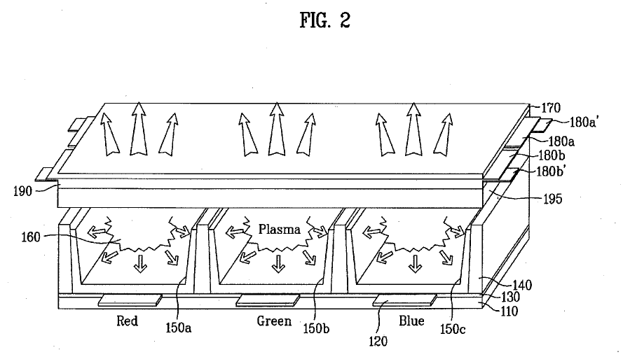

As shown in FIG. 2, an implementation of a plasma display panel includes a front substrate 170 formed with sustain electrode pairs extending in a direction. The sustain electrode pairs include a pair of transparent electrodes 180a and 180b, which are conventionally made of indium tin oxide (ITO), and bus electrodes 180a′ and 180b′, which are conventionally made of a metal material. An upper dielectric layer 190 and a protective layer 195 are sequentially formed over a surface of the front substrate 170, to cover the sustain electrode pairs.

The front substrate 170 is formed, for example, by milling and cleaning a glass for a display substrate. Here, the transparent electrodes 180a and 180b are formed, for example, by a sputtering and photo-etching method or a chemical vapor deposition (CVD) and lift-off method of indium tin oxide (ITO) or SnO₂. The bus electrodes 180a′ and 180b′ are formed of, for example, silver (Ag). Additionally, a black matrix can be formed on the sustain electrode pairs. The black matrix is formed of a low-melting-point glass, black pigment, etc.

The upper dielectric layer 190 is formed on the front substrate 170, which was formed with the transparent electrode 180a and 180b and bus electrodes 180a, and 180b′. Here, the upper dielectric layer 190 is formed of a transparent low-melting-point glass, and a detailed composition thereof will be described hereinafter. Then, the protective layer 195 is formed on the upper dielectric layer 190 using magnesium oxide, etc. The protective layer 195 serves to protect the upper dielectric layer 190 from a positive (+) ion shock caused during a discharge, and to increase a discharge efficiency of secondary electrons.

Meanwhile, the plasma display panel further includes a back substrate 110, which is formed at a surface thereof with address electrodes 120 extending in a direction orthogonal to the sustain electrode pairs. A white dielectric layer 130 is formed over the back substrate 110, to cover the address electrodes 120. The white dielectric layer 130 is formed by coating a dielectric material using a printing method or film laminating method, and baking the coated dielectric material. Then, barrier ribs 140 are formed on the white dielectric layer 130 such that they are arranged between the respective neighboring address electrodes 120. The barrier ribs 140 can be of a stripe-type, well-type, or delta-type.

Here, the barrier ribs 140 are formed of an inorganic material such as, for example, a parent glass and filler, and an organic material such as for example a solvent, binder and dispersant. The parent glass is classified into a lead-based parent glass and a lead-free parent glass. The lead-based parent glass includes ZnO, PbO, B₂O₃, etc., and the lead-free parent glass includes ZnO, B₂O₃, BaO, SrO, CaO, etc. Also, the filler is any one of SiO₂, Al₂O₃, ZnO, TiO₂, etc.

Most organic materials are almost removed during a baking process, but an acrylate-based binder can be left partially. This is because, in the case of a hybrid binder, organic and inorganic materials are linked with each other such that the organic and inorganic materials define a network, thereby preventing the organic material from being completely removed during a baking process. That is, as a result of linking a binder having properties of an organic material with an inorganic material, it is possible to solve a problem of the above described large refractive index difference of the photosensitive barrier rib material without adjusting refractive indices of organic and inorganic materials constituting the photosensitive barrier rib material. The hybrid hinder has a feature that an acrylate-based binder is linked with a parent glass, etc. as a constituent material of a barrier rib.

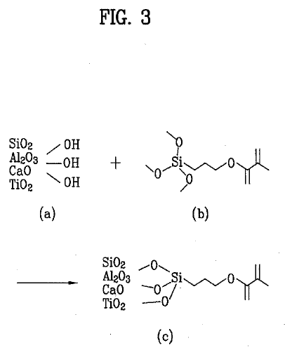

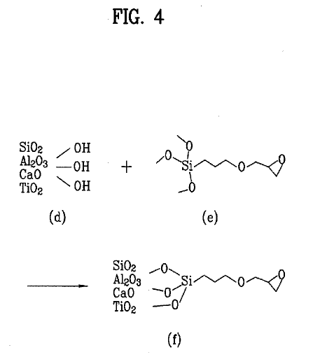

Now, a method for forming a hybrid binder will be described with reference to FIGS. 3 and 4.

First, as shown in FIG. 3, at (a) or in FIG. 4, at (d), an inorganic material is prepared. Here, the inorganic material includes a parent glass, filler, etc. The parent glass can contain SiO₂, Al₂O₃, CaO, TiO₂, etc. Also, the filler serves to assist the parent glass, etc. to keep the shape of a barrier rib.

To link the inorganic material with a binder that will be described hereinafter, the inorganic material is synthesized with hydroxyl ions (OH⁻) using a negative ion polymerization. More specifically, the inorganic material is linked with hydroxyl ions (OH⁻) for encapsulation thereof. It is known that a general synthesizing method achieves only a yield of about 10%, but the negative ion polymerization can achieve a yield of about 90% under a vacuum condition.

After preparing the inorganic material by the above described method as shown in FIG. 3 at (a) or FIG. 4 at (d), a binder is synthesized with the inorganic material. The binder may be an acrylate-based binder, and so formed, the acrylate-based binder may have a high molecular weight functional group attached to a side chain. Accordingly, 3-(Trimethoxysilyl) propyl methacrylate shown in FIG. 3 at (b) or 3-Glycidoxypropyltrimethoxysilane shown in FIG. 4 at (e) can be used as the binder.

With the above described process, a hybrid binder can be synthesized. The hybrid binder contains the inorganic material and organic binder linked with each other, and has a refractive index of 1.4 to 1.6. The hybrid binder can achieve a small refractive index difference between the inorganic material and the organic binder, as compared to a conventional binder obtained by synthesizing inorganic and organic materials. More specifically, a refractive index difference between the above described inorganic material and acrylate-based binder is about 0.15 to 0.2. The above described photosensitive barrier rib material has a BBO temperature of 450˜500° C., thereby allowing the organic material thereof to be completely removed during a baking process that is performed to form the barrier ribs of the plasma display panel. That is, in the case of the conventional photosensitive barrier rib material, although a bulky group should be attached to a side chain to increase a refractive index of the organic material, this results in a barrier rib material in the form of a paste, and the resulting barrier rib material suffers from a raised BBO temperature. The barrier rib material has the effect of solving a problem of the raised BBO temperature.

More specifically, the resulting barrier rib contains 0.1˜0.2% of an organic material component. In turn, the organic material component contains 0.01˜0.06% of the acrylate-based binder.

Although not shown, a black top can be formed on the barrier ribs 140. Red (R), green (G), and blue (B) phosphor layers 150a, 150b, and 150c are formed between the respective neighboring barrier ribs 140. Locations where the address electrodes 120 on the back substrate 110 intersect the sustain electrode pairs on the front substrate 170 are regions defining discharge cells, respectively.

The front substrate 170 and the back substrate 110 are bonded with each other while interposing the barrier ribs 140 therebetween by use of a sealing material provided along the outline of the substrate.

Also, an upper panel including the front substrate 170 and a lower panel including the back substrate 110 are connected with a driving apparatus.

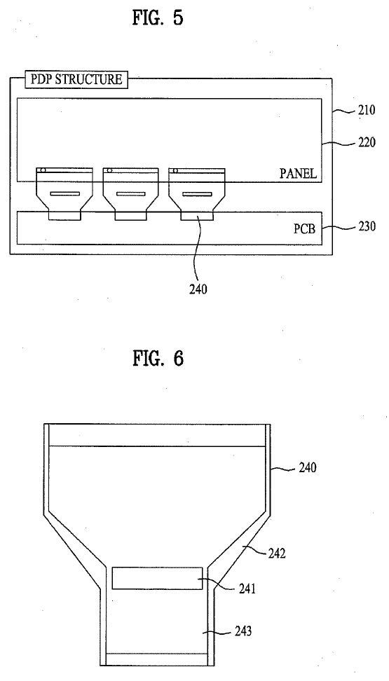

FIG. 5 is a view illustrating a driving apparatus and a connector of the plasma display panel. Hereinafter, the driving apparatus and connector of the plasma display panel having the above described configuration will be described with reference to FIG. 5.

As shown, a plasma display device includes a panel 220, a driving substrate 230 to supply a driving voltage to the panel 220, and a tape carrier package 240 (hereinafter, referred to as a “TCP”) as one kind of a soft substrate that connects electrodes in relation to respective cells of the panel 220 with the driving substrate 230. Here, the panel 220, as described above, includes the front substrate, back substrate, and barrier ribs.

Electrical and physical connections between the TCP 240 and the panel 220 and electrical and physical connections between the TCP 240 and the driving substrate 230 are obtained by use of an anisotropic conductive film (hereinafter, referred to as “ACF”). The ACF is a conductive resin film formed using nickel (Ni) balls each coated with gold (Au).

FIG. 6 is a view illustrating a general substrate wiring structure of the TCP.

As shown, the TCP 240 serves to connect the panel 220 and the driving substrate 230 with each other, and is equipped with a driving driver chip. The TCP 240 includes a wiring 243 densely arranged on a soft substrate 242, and a driving driver chip 241 connected with the wiring 243 and adapted to supply power transmitted from the driving substrate 230 to a specific electrode on the panel 220. Here, since the driving driver chip 241 is configured to alternately output many high-power signals upon receiving low voltages and driving control signals, it has a small number of wiring connected with the driving substrate 230 and a large number of wiring connected with the panel 220. As a result, the wiring connection of the driving driver chip 241 is accomplished through a space toward the driving substrate 230. Also, the wiring 243 may be not bounded about the center of the driving driver chip 241.

FIG. 7 is a view diagrammatically illustrating a plasma display panel.

In the present implementation, the panel 220 is connected with the driving apparatus through a flexible printed circuit 250 (hereinafter, referred to as a “FPC”). Here, the FPC 250 is a film having an interior pattern formed of polyimide. Similarly, in the present implementation, the FPC 250 and the panel 220 are connected with each other by the ACF. Of course, in the present implementation, the driving substrate 230 is a PCB circuit.

The driving apparatus includes, for example, a data driver, a scan driver, and a sustain driver. The data driver is connected with address electrodes, to apply a data pulse. The scan driver is connected with scan electrodes, to supply a Ramp-up waveform, Ramp-down waveform, scan pulse, and sustain pulse. The sustain driver applies a sustain pulse and DC voltage to common sustain electrodes.

The plasma display panel is driven for a time frame that is divided into a reset period, an address period, and a sustain period. During the reset period, a Ramp-up waveform is applied to all scan electrodes simultaneously. During the address period, a negative polarity scan pulse is sequentially applied to the scan electrodes. Simultaneously with the sequential application, a positive polarity data pulse is synchronized with the scan pulse, to thereby be applied to the address electrodes. Also, during the sustain period, a sustain pulse is applied alternately to the scan electrodes and the sustain electrodes.

In another implementation, the above described hybrid binder may be used in the dielectric layer 130 formed on the back substrate 110. Specifically, the white dielectric layer 130 is formed of a parent glass, filler, and hybrid binder. In this case, the white dielectric layer 130 and barrier ribs 140 can be baked together. Since the hybrid binder contains an organic binder with properties of an inorganic material, the strength of the barrier ribs 140 can be enhanced, and also, a bonding force between the barrier ribs 140 and the lower dielectric layer 130 can be enhanced.

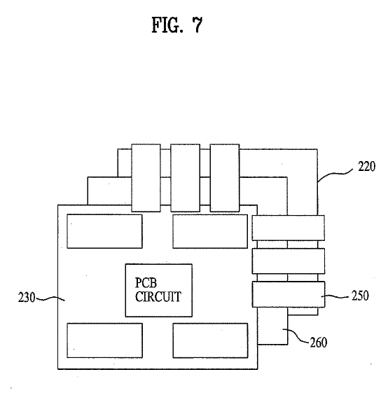

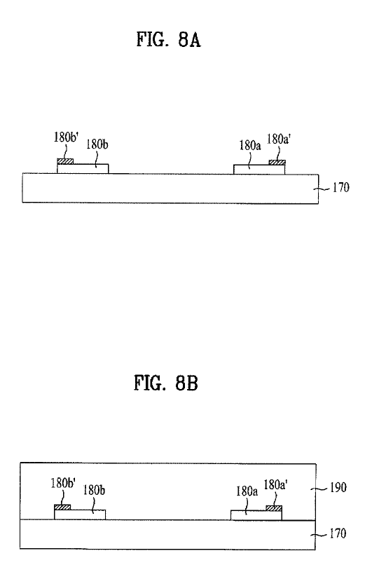

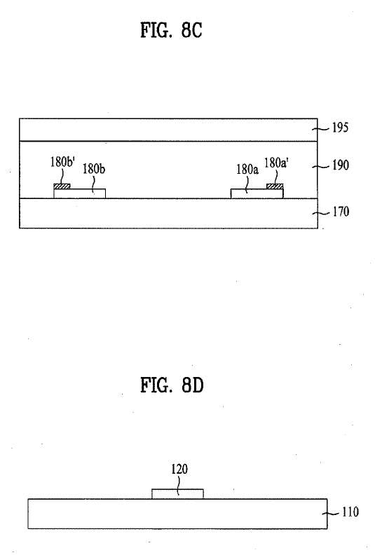

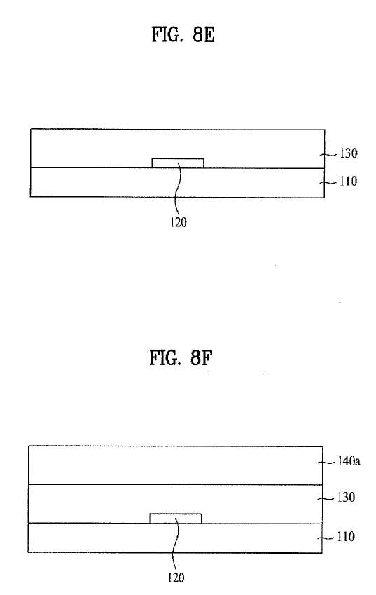

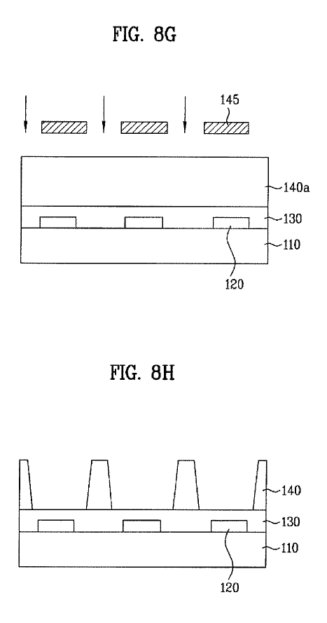

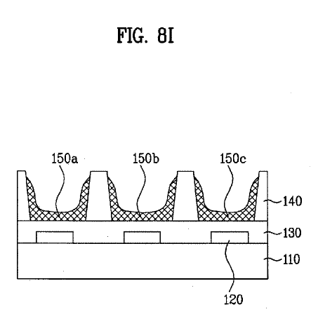

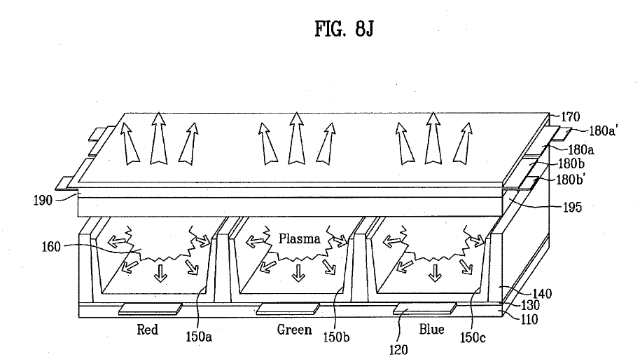

FIGS. 8A to 8J are views illustrating an implementation of a method for manufacturing the plasma display panel. Now, a method for manufacturing the plasma display panel will be described with reference to FIGS. 8A to 8J.

First, as shown in FIG. 8A, the transparent electrodes 180a and 180b and bus electrodes 180a, and 180b′ are formed on the front substrate 170. Here, the front substrate 170 is formed by milling and cleaning a glass for a display substrate or sodalime glass. The transparent electrodes 180a and 180b are formed, for example, by a sputtering and photo-etching method or a chemical vapor deposition (CVD) and lift-off method using indium tin oxide (ITO) or SnO². The bus electrodes 180a′ and 180b′ are formed, for example, by a screen printing method or photosensitive paste method using silver (Ag). A black matrix can be formed on the sustain electrode pairs, for example, by a screen printing method or photosensitive paste method using a low-melting-point glass, black pigment, etc.

After completely forming the transparent electrodes 180a and 180b and bus electrodes 180a′ and 180b′, as shown in FIG. 8B, the upper dielectric layer 190 is formed on the front substrate 170 by stacking a material containing low-melting-point glass, etc. using a screen printing method, coating method, green sheet laminating method, or the like.

Then, as shown in FIG. 8C, the protective layer 195 is deposited on the upper dielectric layer 190. The protective layer 195 is formed of, for example, magnesium oxide, and can further contain a dopant such as silicon, etc. Here, the protective layer 195 can be formed using a chemical vapor deposition (CVD) method, E-beam method, ion plating method, sol-gel method, sputtering method, or the like.

After completing the formation of the protective layer 195, as shown in FIG. 8D, the back substrate 110 having the address electrode 120 is formed. First, the back substrate 110 is formed, for example, by milling and cleaning a glass for a display substrate or sodalime glass. Then, the address electrodes 120 are formed on the back substrate 110. The address electrodes 120 are formed by a screen printing method, photosensitive paste method, or sputtering/photo-etching method using, for example, silver (Ag).

Then, as shown in FIG. 8E, the lower dielectric layer 130 is formed on the back substrate 110 formed with the address electrodes 120. The lower dielectric layer 130 is formed of a paste, which is prepared by mixing a glass and vehicle in an organic solvent. In this case, the lower dielectric layer material is a glass-ceramics material having a reflectivity of about 50% against visible rays. The prepared paste is coated over the back substrate 110 formed with the address electrodes 120 using a screen printing method, to have a thickness of about 20˜30 μm. By drying and baking the lower dielectric layer material, the lower dielectric layer 130 is completed. In this case, the drying temperature is about 100° C., and the baking temperature is about 500˜550° C. Of course, it is natural that the above mentioned drying temperature and baking temperature can be changed according to constituent components and compositions of the lower dielectric layer material.

The above described method is one example of a process for forming the lower dielectric layer using a screen printing method. Hereinafter, a process for forming the lower dielectric layer using a green sheet method will be described in brief. First, after coating a base film with a dielectric layer material, the resulting dielectric layer material is covered with a protective cover film, to prepare a green sheet. Then, the green sheet is laminated on a glass back substrate while removing the base film from the green sheet. By baking the laminated green sheet after removing the protective cover film, the lower dielectric layer is completed. The formation of the lower dielectric layer using the above described green sheet laminating method has several advantages of uniform layer thickness, superior surface flatness, simplified process, and high productivity, but has a disadvantage of expensive material costs.

The lower dielectric layer 130 formed by the above described method is adapted to reflect visible rays back-scattered from phosphor layers. As a result, the lower dielectric layer 130 can serve to increase the brightness of the plasma display panel and to prevent diffusion of atoms discharged from the address electrodes.

Subsequently, as shown in FIGS. 8F to 8H, the barrier ribs for defining discharge cells are formed.

First, a photosensitive barrier rib material 140a containing a hybrid binder is prepared. Here, the hybrid binder has a feature that it contains an acrylate-based binder prepared by the above described process and the acrylate-based binder is linked with an inorganic material. As other features of the hybrid binder, a refractive index difference between the inorganic material and the acrylate-based binder is 0.15 to 0.2, a refractive index of the hybrid binder is about 1.4 to 1.6, and the inorganic material is any one of SiO₂, Al₂O₃, CaO, and TiO₂. Also, the acrylate-based binder is 3-(Trimethoxysilyl) propyl methacrylate and/or 3-Glycidoxypropyltrimethoxysilane, and the hybrid binder has a BBO temperature of 450˜500° C.

Thereafter, as shown in FIG. 8F, the photosensitive barrier rib material 140a is stacked on the back substrate 110 (the lower panel). Here, the stacking of the photosensitive barrier rib material 140a is performed by first preparing the photosensitive barrier rib material in the form of a green sheet, and laminating the green sheet on the back substrate 110.

Thereafter, as shown in FIGS. 8G and 8H, the photosensitive barrier rib material 140a is subjected to certain processes, to form the barrier ribs 140. Specifically, in this example, the photosensitive barrier rib material can be patterned by selectively exposing the photosensitive barrier rib material 140 after covering it with a mask 145, and developing the exposed photosensitive barrier rib material 140a. In this case, by virtue of a small refractive index difference between the organic material and the inorganic material constituting the photosensitive barrier rib material 140a, light can be irradiated to the bottom of the barrier rib material 140a. As a result, the resulting barrier rib 140 can achieve an improved aspect ratio. After completing the developing process, locations of the barrier rib material 140a where light is irradiated remain. Finally, the barrier ribs 140 are completed by performing a baking process. Here, the backing process can be performed at a temperature of about 550˜600° C. Since the above described photosensitive barrier rib material has a BBO temperature of about 450˜500° C., the organic material in the barrier rib material can be completely removed by the baking process.

As a result, since there is no organic material residue after completing the baking process, there are no problems of, for example, a deterioration in reflectivity caused by color tubidity of the barrier ribs, and consequently, a deterioration in brightness and color temperature, and out-gassing during a discharge. Also, since a hybrid binder contains an organic material with properties of an inorganic material, it can achieve the effect of improving the strength of the barrier ribs as compared to barrier ribs made of a conventional photosensitive barrier rib material. With the improved strength of the barrier ribs, also, a bonding force between the barrier ribs and the lower dielectric layer can be enhanced.

The above described lower dielectric layer material may be prepared to contain the hybrid binder included in the photosensitive barrier rib material. In the present implementation, although the above described barrier rib material contains the hybrid binder and can solve a refractive index problem represented by a conventional photosensitive barrier rib material, the lower dielectric layer material is not subjected to an exposure process and thus, is free from the refractive index problem. However, adding the hybrid binder to the lower dielectric material has the effect of increasing the strength of the lower dielectric layer material, similar to the barrier ribs.

As a binder to link a glass, etc. as a constituent material of the lower dielectric layer with an organic solvent, etc., a hybrid binder containing an acrylate-based binder can be used. In this case, similarly, to link an inorganic material with the binder, the inorganic material is synthesized with hydroxyl ions (OH⁻) using a negative ion polymerization. Then, by adding the acrylate-based binder into the inorganic material synthesized by the negative ion polymerization, the hybrid binder can be prepared. In this case, as described above, the acrylate-based binder may have a high molecular weight functional group attached to a side chain. Also, as described above, 3-(Trimethoxysilyl) propyl methacrylate or 3-Glycidoxypropyltrimethoxysilane can be used as the binder.

The hybrid binder synthesized by the above described process has a BBO temperature of 450˜550° C. Therefore, the dielectric layer material and the barrier rib material can be baked together.

With the above described baking process, only a part of the hybrid binder linked with the inorganic material remains. Specifically, since the organic and inorganic materials contained in the binder define a network, the organic material is not completely removed. More specifically, the barrier rib contains 0.1˜0.2% of an organic material component. In turn, the organic material component contains 0.01˜0.06% of the acrylate-based binder.

Then, as shown in FIG. 8I, the phosphor layers 150a, 150b, and 150c are coated on a surface of the lower dielectric layer 130 facing the discharge space, and both side surfaces of the barrier ribs 140. The phosphor layers 150a, 150b, and 150c are red, green, and blue phosphor layers sequentially coated in respective corresponding discharge cells using a screen printing method or photosensitive paste method.

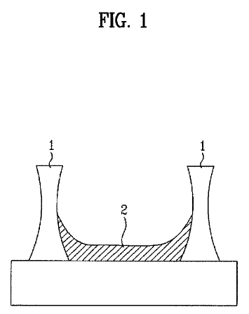

As shown, the barrier ribs 140 have a shape similar to a trapezoid, and the phosphor layers 150a, 150b, and 150c can be sufficiently coated onto side surfaces of the barrier ribs 140. Accordingly, as compared to the conventional barrier ribs and phosphor layers coated thereto as shown in FIG. 1, it can be appreciated that the total coating area of the phosphor layers can be increased. In the above described process, the barrier ribs are formed by externally exposing and developing the photosensitive paste. As a result, as compared to barrier ribs having a very rough surface formed by a sanding method, the barrier ribs according to the present implementation can achieve a greatly smooth surface. Also, the barrier ribs according to the present implementation can achieve a greatly smooth surface as compared to a very sharp barrier rib formed by an etching method.

As shown in FIG. 8J, after bonding and sealing the front substrate 170 as an upper panel and the back substrate 110 as a lower panel such that the barrier ribs are interposed therebetween, a discharge gas 160 is injected after exhausting interior impurities, etc.

Hereinafter, a process for sealing the upper and lower panels will be described in detail. The sealing process is performed using a screen printing method, dispensing method, or the like. In the screen printing method, after a patterned screen is located above a substrate with a predetermined distance therebetween, a paste required to form a sealing material is squeezed and transferred, so as to print a desired shape of sealing material. The screen printing method has advantages of simplified production facility and high material use efficiency.

In the dispensing method, a thick-layer forming paste is directly discharged onto a substrate using an air pressure according to CAD wiring data used in the manufacture of a screen mask, to form a sealing material. The dispensing method has advantages of reducing mask manufacturing costs and achieving a great freedom in the formation of a thick layer.

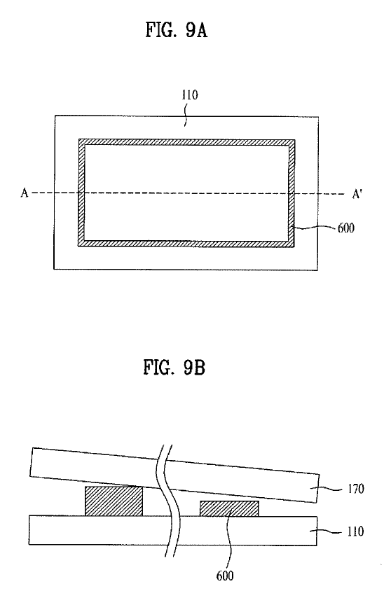

FIG. 9A is a view illustrating a process for bonding the front substrate and the back substrate of the plasma display panel with each other, and FIG. 9B is a sectional view taken along the line A-A′ of FIG. 9A.

As shown, a sealing material 600 is coated on the front substrate 170 or the back substrate 110. Specifically, the sealing material 600 is printed or coated using a dispensing method at a position spaced apart from the outline of the substrate by a predetermined distance.

Subsequently, the sealing material 600 is subjected to a baking process. During the baking process, the organic material contained in the sealing material 600 is removed, and the front substrate 170 and the back substrate 110 are bonded with each other. Also, with the baking process, the sealing material 600 can be increased in width and decreased in height. In the present implementation, although the sealing material 600 is printed or coated, a sealing tape may be attached to the front substrate or the back substrate.

Then, an aging process can be performed to improve, for example, characteristics of the protective layer under a predetermined temperature condition.

Additionally, a front filter can be formed on the front substrate. The front filter includes an electromagnetic interference (EMI) shielding layer to prevent electromagnetic waves from being emitted from the panel to the outside. The EMI shielding layer may be formed by patterning a conductive material to have a specific pattern, in order to achieve a desired visible ray transmission required in a display device while shielding the electromagnetic waves. The front filter can be formed with a near-infrared shielding layer, a color compensating layer, an anti-reflection layer, etc.

It will be apparent that various modifications and variations can be made.

What is claimed is:

1. A method for manufacturing a plasma display panel comprising:
forming address electrodes and a first dielectric layer on a first side of a first substrate;
positioning barrier ribs by stacking a photosensitive barrier rib material, including a hybrid binder, on the first side of the first substrate, and processing the stacked photosensitive barrier rib material;
positioning phosphor layers in respective cells defined by the barrier ribs;
sequentially positioning at least one pair of transparent and bus electrodes, a second dielectric layer, and a protective layer on a first side of a second substrate; and
fixing a position of the first substrate relative to a position of the second substrate, with the first side of the first substrate facing the first side of the second substrate.

2. The method according to claim 1, further comprising forming the photosensitive barrier rib material by preparing an inorganic material linked with hydroxyl ions, and synthesizing the inorganic material with an acrylate-based binder.

3. The method according to claim 2, wherein the acrylate-based binder is at least one of 3-(Trimethoxysilyl) propyl methacrylate and 3-Glycidoxypropyltrimethoxysilane.

4. The method according to claim 2, further comprising linking the inorganic material with the hydroxyl ions using a negative ion polymerization.

5. The method according to claim 2, wherein the barrier rib material further includes an inorganic material, and a refractive index difference between the inorganic material and the acrylate-based binder is 0.15 to 0.2.

6. The method according to claim 1, further comprising stacking the photosensitive barrier rib material by laminating the photosensitive barrier rib material in the form of a green sheet on the first substrate.

7. The method according to claim 1, further comprising processing the stacked photosensitive barrier rib material by externally exposing and developing the photosensitive barrier rib material, and then, baking the developed photosensitive barrier rib material.

8. The method according to claim 7, further comprising baking the developed photosensitive barrier rib material at a temperature of 550˜600° C.

9. The method according to claim 1, wherein the phosphor layers are positioned in respective cells defined by the barrier ribs by coating phosphor on the first dielectric layer and side surfaces of the barrier ribs.

10. A method for manufacturing a plasma display panel comprising:
positioning a first dielectric layer material, including a hybrid binder, on a first side of a first substrate and address electrodes;
stacking a photosensitive barrier rib material, including a hybrid binder, on the first dielectric layer material, and externally exposing and developing the stacked photosensitive barrier rib material;
simultaneously baking the first dielectric layer material and barrier rib material, to form a first dielectric layer and barrier ribs;
positioning phosphor layers in respective cells defined by the barrier ribs;
sequentially positioning at least one pair of transparent and bus electrodes, a second dielectric layer, and a protective layer on a second substrate; and
fixing a position of the first substrate relative to a position of the second substrate, with the first side of the first substrate facing the first side of the second substrate.

11. The method according to claim 10, further comprising forming the first dielectric layer material by preparing an inorganic material linked with hydroxyl ions, and synthesizing the inorganic material with an acrylate-based binder.

12. The method according to claim 11, further comprising linking the inorganic material with the hydroxyl ions using a negative ion polymerization.

13. The method according to claim 11, wherein the barrier rib material further includes an inorganic material, and a refractive index difference between the inorganic material and the acrylate-based binder is 0.15 to 0.2.

14. The method according to claim 10, further comprising baking the first dielectric layer material and barrier rib material at a temperature of 550˜600° C.

15. A plasma display panel comprising:
a first panel including address electrodes, a first dielectric layer, and phosphor layers positioned on a first side of a first substrate;
a second panel including sustain electrode pairs, a second dielectric layer, and a protective layer positioned on a first side of a second substrate; and
barrier ribs provided between the first panel and the second panel and including a parent glass and filler as an inorganic material, and acrylate-based binder.

16. The plasma display panel according to claim 15, wherein the barrier ribs include 0.01˜0.06 wt % of the acrylate-based binder.

17. The plasma display panel according to claim 15, wherein a refractive index difference between the inorganic material and the acrylate-based binder is 0.15 to 0.2.

18. The plasma display panel according to claim 15, wherein the barrier ribs have a refractive index of 1.4 to 1.6.

19. The plasma display panel according to claim 15, wherein the acrylate-based binder is at least one of 3-(Trimethoxysilyl) propyl methacrylate and 3-Glycidoxypropyltrimethoxysilane.

20. The plasma display panel according to claim 15, wherein the first dielectric layer includes a parent glass, filler, and acrylate-based binder.
